(19) United States
(12) Patent Application Publication
(10) Pub. No.: US 2020/0247454 A1
(43) Pub. Date: Aug. 6, 2020

(54) Leaf Skid Apparatus

(71) Applicant: Mark Edward Perkins, III, Dunkirk, MD (US)

(72) Inventor: Mark Edward Perkins, III, Dunkirk, MD (US)

(21) Appl. No.: 16/264,672

(22) Filed: Jan. 31, 2019

(51) Int. Cl. B62B 15/00

(52) U.S. Cl. CPC B62B 15/007; B62B 2202/50

(57) ABSTRACT

The Leaf Skid Apparatus is a tarpaulin like structure that has two ends hemmed to create cavities that house a semi-rigid beam in front and a weight at the rear. Grommets are strategically placed to allow a pulling device to effectively distribute the weight and secure the beam in the structure. Additional grommets are utilized in the rear to secure the weight and to allow the structure to be staked to the ground. This apparatus can be manufactured using well established methods and materials while requiring a modest amount of labor. It can be transported and displayed in its storage container and offers a manufacture or retailer an effective tool for marketing by including a logo on the top surface. As a very useful and time/energy saving tool that can be sold for an affordable amount, it will appeal to home owners and yard maintenance professionals alike.

### CROSS REFERENCE TO RELATED APPLICATIONS

| | | |
|---|---|---|
| 3,355,187 | Aug. 28, 1967 | Brindle |
| 5,104,133 | Apr. 14, 1992 | Reiner |
| 6,565,101 | May 20, 2003 | Jones |
| 8,955,892 | Feb. 17, 2015 | Schumate |
| 9,669,994 | Jun. 6, 2017 | Clevenger |

Cross reference to provisional application by Inventor #62/624,836 on Feb. 1, 2018

### BACKGROUND OF THE INVENTION

### Field of the Invention

This invention relates to the need for property owners to address the periotic build up of leaves and yard debris. It represents a very cost effective and easy to use tool to collect and move debris to a wooded area, composting area, or collection area.

### Description of the Related Art

Any discussion of the prior art throughout the specification should in no way be considered as an admission that such prior art is widely known or forms part of common general knowledge in the field.

Through time tools have been developed to move leaves and plant debris, most common are the various types of rakes. Devices to blow leaves where desired are now more prevalent weather they are electric or gas powered. Some people have combined a rake and a large sheet such as an old bedspread to speed up the process. The leaves could be raked onto the bedspread and be dragged away, or bundled up and lifted over one's shoulder and carried off. A number of patents have been granted for devices for collecting and moving leaves and or yard litter. Most of these involve a sledge like apparatus with runners or some sort of wheeled vehicles, while some others focus on lifting and funneling the leaves into yard waste bags. The problem with prior art is they are either relatively expensive, time consuming in use, difficult to store, have a lot of components to wear out or fail, or are too narrowly focused in their application. My research has identified five US patents that are skid-based apparatus's and are operable by one person. The earliest is #3,355,187 that incorporates a pivoting flat rear mandrel that is hoisted upright when full to form a half boat like structure before moving. The second is a device by Reiner #5,104,133 that has short stiff sections at the rear sides that hold up the rear end of the sheet when being pulled. Third is Jones #6,565,101 a similar design that has a ridged mandrel at the rear with short extensions along the sides that fold up when the rope is pulled as it passes thru grommets along the sides. Forth Shumate #8,955,892 is a skid with some stakes and two rods that form a rear wall. Fifth is Clevenger #9,669,994 that includes several yard working tools one of which is a skid that is sized to slip into a pick-up truck bed.

The common theme with the skid type devices is a perceived need to close in the rear and or sides when in motion. Through extensive use of prototypes that I have developed I am convinced that the amount of leaves that fall off a flat tarpaulin type skid when pulled over uneven ground and sidewalks or driveways is insignificant if any. This knowledge is gained over hundreds of pulls many of which exceeded a hundred feet in length. The most needed attribute that I have identified is the need for the tarp to be able to lie flat on the ground during loading. It is important that it be able to resist a gust of wind that would blow the corners up, and to not catch on the tines of a rake easily; while being reasonably useful when used with a leaf blower. The prior art that depicts rigid or semi-rigid rear mandrels will not allow the tarp to conform to hills, swells, and low spots in a yard, like a thick clump of grass, or in a driveway. This assures that they will prove tedious and time consuming in use. The other concerns I have with the prior art is the time and effort required to and make it ready for use. The more complicated it is the more tedious and time consuming it will be to set it up for use. Likewise, the more steps it takes before it can be moved, as in pulling up props or extensions of some kind, the more time will be consumed, and the more bending over and physical effort will be expended in use. The designs that include a short section that is pulled up vertical once underway would endure a real risk of getting caught on or snagging part of the ground, making them a challenge to drag. As to the designs that make a ‘half boat’ like object when pulled, it would appear to me the risk of capsizing is real. Since leaves and tree litter are typically collected once in late Spring and numerous time in the Fall, these devices will spend most of their time in storage, placing a premium on space utilization; and the more complex and greater the number of parts the more difficult storage becomes.

As to the non-skid type apparatus's that have been disclosed over the years, these all fail the storage criteria, are more expensive to manufacture and purchase, are more difficult to load and off load, and as such I am not aware of any that are in use.

### BRIEF SUMMARY OF THE INVENTION

The present invention overcomes the problems with prior art. The present invention does this by fulfilling these four design objectives: affordability, ease of use, efficient in storage, effective at saving time and energy. Affordability is accomplished by being inexpensive to manufacture using well established production methods and practices, thus allowing it to be sold to an end user at an affordable price. It is efficient in storage as it is shipped to a warehouse or sells location by placing it in its own storage container that can have point of purchase advertisements included on it along with identifying information. In use the product is very close to intuitive as it is simple to understand and operate. This invention will save the operator a considerable amount of time and effort, in that they will not have to keep moving the same material over and over to get it where desired. The product consists of a tarpaulin like device that has two of the ends hemmed to create pockets to hold a solid draw bar at one end and a ground conforming weight (my acronym GCW) at the other. Grommeted openings are placed strategically to retain the draw bar, GCW, pull rope, and any ground stakes that may be desired. A rope is attached thru the tarp and draw bar to pull the device. In use the operator need but retrieve it from its place of storage, remove it from the storage container and cart it to the start place of choice. Once there it is rolled out and is immediately ready to accept leaves or debris. Once the leaves in the immediate area are all loaded the skid can be pulled forward and have more material added until determined full, after which it would be dragged to a desired location to be dumped.

### BRIEF DESCRIPTION OF THE DRAWINGS

FIG. 1 is a plan or top view of the present invention illustrating the components that make up the preferred embodiments.

FIG. 2 is a top view of the tarpaulin showing the hemmed ends and grommeted holes strategically placed.

FIG. 2.1 is a side view of tarpaulin showing the cavities formed by hemming the ends.

FIG. 3 is a top view of draw bar with radiused corners in front and location of holes.

FIG. 3.1 is a perspective view to show overall proportions of draw bar.

FIG. 4 is a top view of ground conforming weight with pockets for weights and retention holes.

FIG. 4.1 is a side view showing individual pockets and weights (drawn as though top part of sleeve were clear).

FIG. 4.2 is a perspective view to show relative proportions of ground conforming weight.

FIG. 5 is a plan view of the first alternative GCW, a series of weights linked together.

FIG. 5.1 is a side view of the first alternative GCW showing the loose-fitting staples and common zip ties as optional securing method.

FIG. 5.2 is a perspective view of the second alternative GCW.

FIG. 5.3 is a top view of the third alternative GCW showing a chain hemmed into a sleeve.

FIG. 6 is a plan view of the handle with rope, the hammer/puller tool, ground stakes, foldable wall mount, and shipping-display-storage container.

FIG. 7 is a perspective view of another alternate GCW.

### DETAILED DESCRIPTION OF THE INVENTION

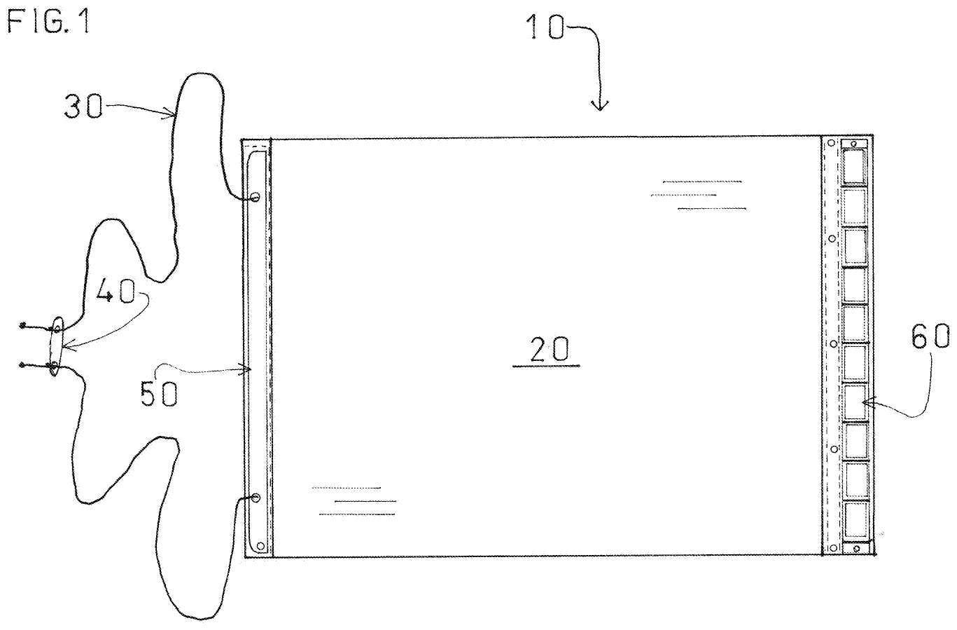

Overview: In FIG. 1 leaf skid 10 is illustrated lying flat with handle 40 attached to rope 30 that is passed through tarpaulin 20 and draw bar 50, with ground conforming weight 60 (my acronym GCW) at opposite end.

The size of the apparatus is highly scalable and the application of the draw bar 50 can be internal as shown or external with multiple connection points. The GCW 60 (GCW), likewise could easily be adapted to function outside either attached to tarpaulin 20, or laid on top with or without the use of ground stakes.

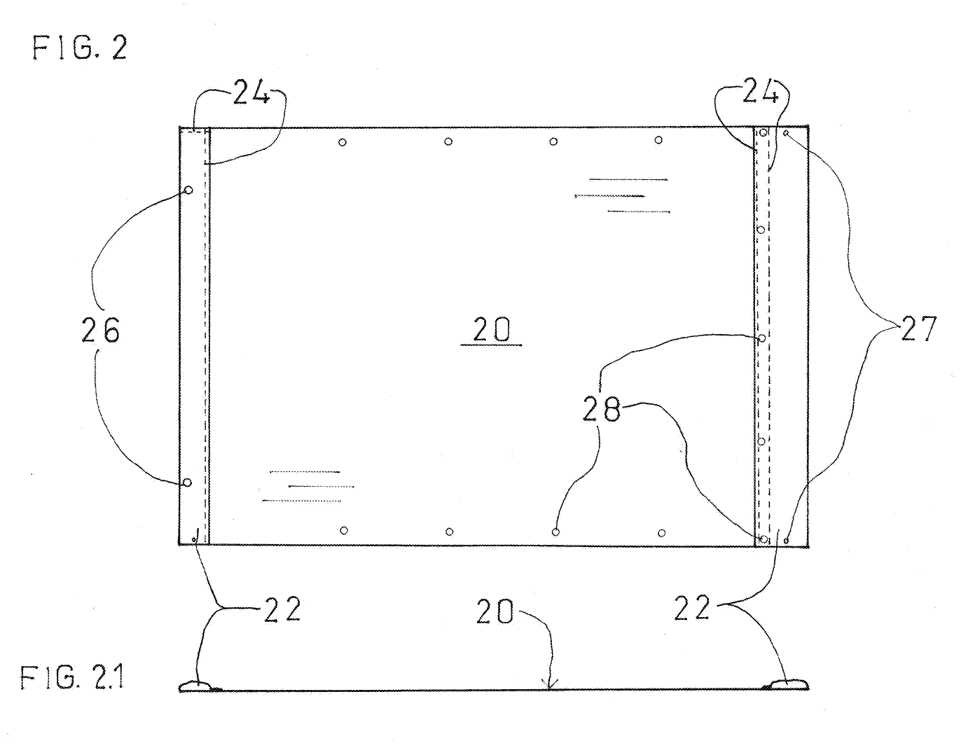

Tarpaulin: In FIG. 2 the tarp 20 is illustrated lying flat with hem stitching 24 at ends, and holes 26 are depicted at locations to attach rope (not shown), and holes 27 at locations to retain draw bar and GCW (not shown), and holes 28 for ground stakes (not shown).

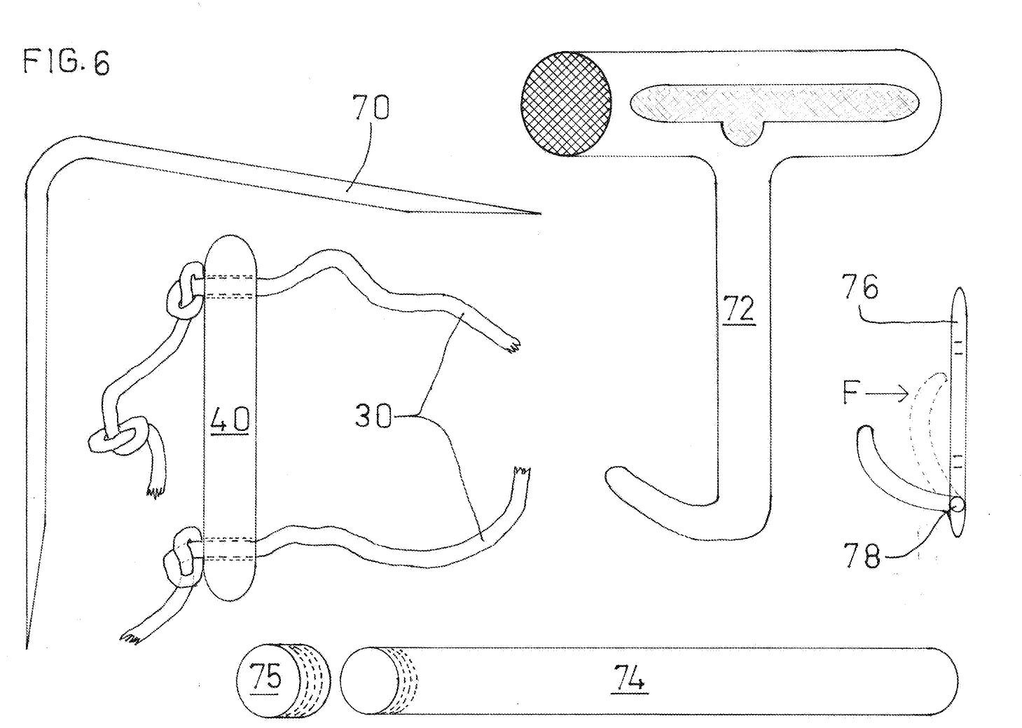

The tarpaulin could be constructed of any suitable sheet good material, a plastic mat or sheet, or a woven organic or synthetic fiber material. Desired attributes are abrasion resistance on the bottom surface and adequate tear strength where it contacts the draw bar. Holes for ground stakes are optional as they would most likely only be used with a blower. Both FIG. 1 and FIG. 2 show the rear ground stake holes in front of the GCW, thus the ground stakes shown in FIG. 6 are extended to hold down the rear edge, however the holes could be at the edge and a common ground stake used instead.

FIG. 2.1 is a side profile to show the flatness of tarpaulin 20 and the two cavities 22 formed by hems 24. In the drawing the hems are depicted as stitching, but could also be accomplished by using an adhesive or thermoplastic welding if certain plastics are used to construct the tarp.

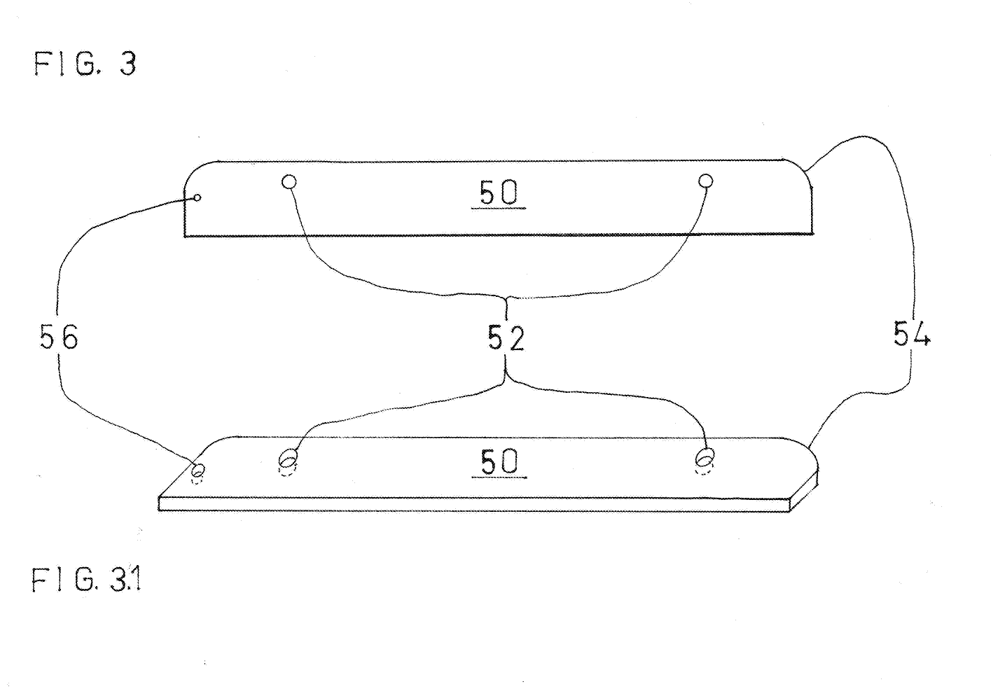

Drawbar: FIG. 3 is a top view of a drawbar 50 showing radiused front corners 54 and rope (not shown) attachment holes 52 and retaining hole 56.

FIG. 3.1 is a perspective view to show proportions. The composition of the drawbar is open to many materials including but not limited to, plastic, fiberglass, metals, wood, and composites. The shape of the drawbar is also open to many and can be as simply as a hollow plastic (PVC) pipe. The design function of the drawbar is to more evenly distribute the force generated on the tarp when pulling a loaded leaf skid, across a wider surface area then just a few grommeted holes as if the rope were attached without the drawbar. The front corners are radiused to relieve stress on the far corners. The rope holes location while not critical will likely perform best on or about the 15 to 25% and 75 to 85% of width locations. This will facilitate good steering control and load distribution. Another important attribute of the drawbar is that it possesses adequate rigidity as when not in use the leaf skid will be rolled up around the drawbar.

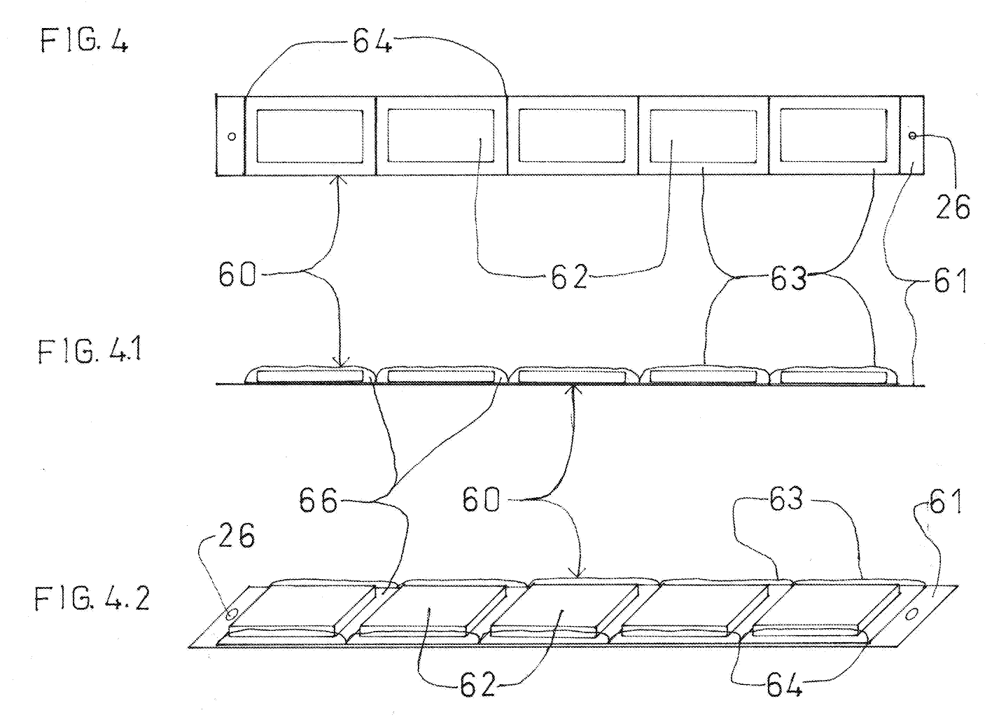

Ground conforming weight: FIG. 4 is a top view of the ground conforming weight 60 showing individual weights 62 inside pockets formed by hems 64 connecting top of sleeve 63 to bottom of sleeve 61, with holes 26 for retaining GCW in tarpaulin (not shown).

FIG. 4.1 is a partial side view of the GCW 60 showing relationship of sleeve bottom 61 and sleeve top 63 (shown clear) that form pockets 66 that contains weights 62.

FIG. 4.2 is a perspective view of GCW 60 that shows sleeve bottom 61 with hems 64 joining sleeve top 63 (shown clear) and forming pockets 66 that house weights 62, and holes 26 for retaining GCW 60 in tarp (not shown).

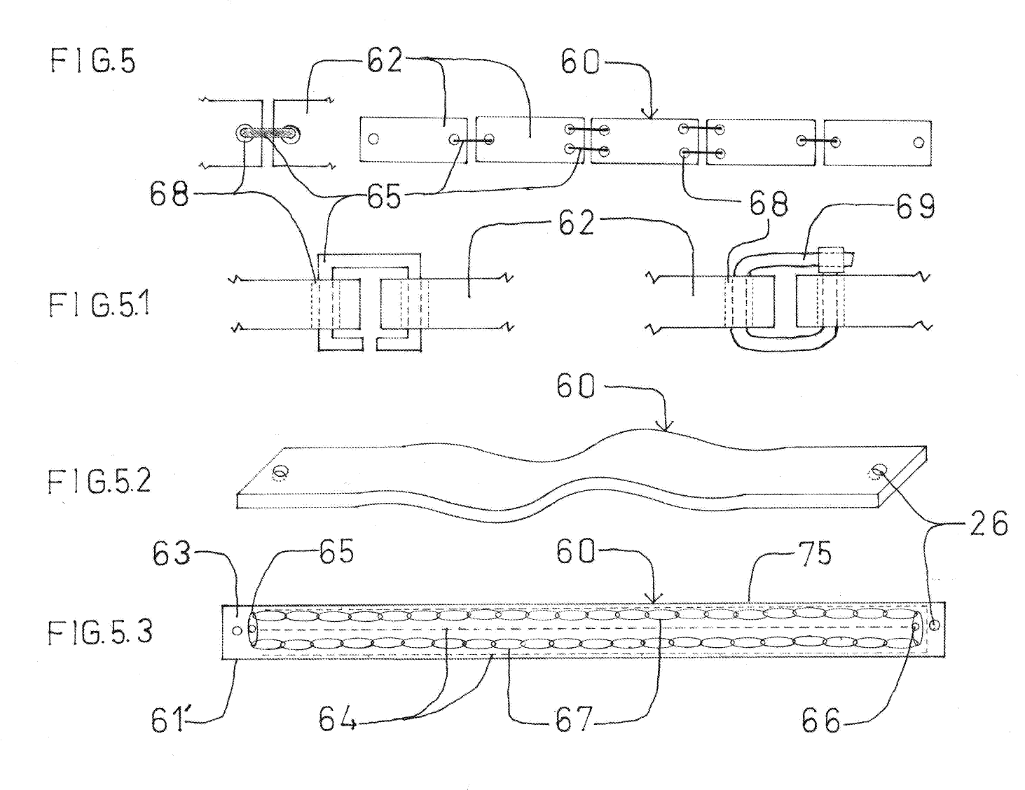

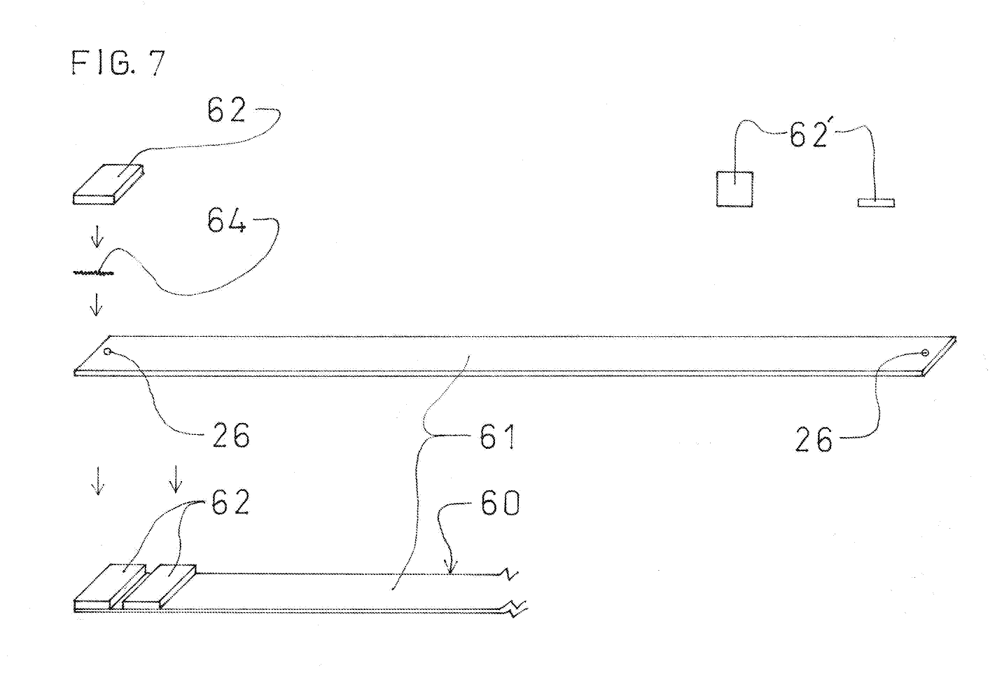

The design purpose of the GCW is to hold the rear edge of the tarp as tight or close to the ground as is practical. Yards and lawns are rarely truly flat as they have high and low spots, and swells are often created to control heavy rains. Even clumps or clusters of grass and or weeds are enough to raise portions of the tarp, while driveways frequently have uneven areas created by broken concrete, or tire ruts in asphalt. Without the GCW the tarp would be much more likely to lift in the wind, and the low spots that it was spread over would encourage leaves and debris being raked or swept onto it to go under the tarp instead. Without the GCW the likelihood of the tarp flipping up when it is caught by a rake tine would be greatly amplified. The drawings in FIGS. 4, 4.1, and 4.2 illustrate the preferred embodiments of the GCW but in no way, should be considered the only way to accomplish the objective. I have included alternatives in FIG. 5, and FIG. 7.

Alternative GCW's: FIG. 5 is a top view of linked weights 60, with weights 62 and links 65 or stapled 65 together to form a GCW.

FIG. 5.1 is a close-up top and side views showing holes 68 in weights 62 larger than the links 65, and a zip tie 69 used in place of a staple as an optional method.

FIG. 5.1 also shows link 65 as non-continuous, i.e. like a staple, and loose fitting with gaps at top and bottom of weights 62 and notable clearance in hole 68. This is done to allow ease of movement and enhance its ability to bend, while also reducing manufacturing cost.

FIG. 5.2 is a perspective view of a solid but flexible weight 60 with locating holes 26 at both ends.

FIG. 5.3 is a top view of sleeve 75 that contains a continuous crimped or welded chain 67 with connector 65, that is enclosed by hems 64 in bottom 61′ and top 63 and retaining holes 66 and 26 to secure chain in sleeve and unit in tarpaulin (not shown).

The above alternatives are in no way meant to be inclusive of all possible ways to weight the tarpaulin to enhance its functionality. An inexpensive metal pipe could be used for cost purposes but would only work well on a relatively flat surface. Any of these three alternatives may prove the most desirable after cost/benefit study. The device in FIG. 5.2 would likely prove best if a material is available that is flexible enough while being adequately heavy. The device in FIG. 5.3 can be configured using any number of loops, or a single loop of chain. All four of the GCW's 60 are held in place in the tarp by a reusable pressed together snap, a threaded fastener or a zip tie, or any other cost-effective means. The GCW's and draw bars need to be removable and replaceable as the tarps will wear out over time from friction after many uses. Installation and replacement can be accomplished by use of a ‘wire snake’ like device that could be included with a replacement tarp.

### ADDITIONAL EMBODIMENTS

FIG. 6 depicts different views of embodiments including a handle 40 showing how rope 30 can be knotted to change length to aid different sized people with ease of operation, a ground stake 70 that is symmetrical and bent at a greater then 90 degree angle to facilitate removal, a combination hammer/puller 72 tool, a foldable wall bracket 76 with hinge 78 that can be shipped in shipping/retail display/storage container 74 with cap 75.

Additional GCW: FIG. 7 depicts a relatively thin very flexible base 61 with a number of weights 62 adhered to it by adhesive 64 with installation securing holes 26 forming a GCW 60. The weights can be made of many materials and attached via rivets, threaded fasteners, zip ties, or adhesive.

The purpose of the above additional embodiments is to enhance the operation of the leaf skid and improve the ownership experience, by making it an all-inclusive purchase.

1. The Leaf Skid Apparatus 10 is a debris transport device, comprising:
a pulling device 30 connected to;
a load distributing element 50 within or attached to;
a flexible structure 20 with;
a weighted element 60 within or attached to the opposite end.

2. The debris transport device of claim 1, wherein the load distributing element 50 is enclosed in the leading edge of the flexible structure 20.

3. The debris transport device of claim 1, wherein the load distributing element 50 is attached to the leading edge of the flexible structure 20.

4. The debris transport device of claim 1, wherein a malleable element that deforms under its own weight 60 is enclosed in the trailing edge of flexible structure 20.

5. The debris transport device of claim 1, wherein a malleable element that deforms under its own weight 60 is attached to the trailing edge of flexible structure 20.

6. The debris transport device of claim 1, wherein the flexible structure 20 has an abrasion resistant coating applied to the bottom side.

7. The debris transport device of claim 1, wherein the flexible structure 20 has a design visible on the surface with a purpose other than to identify the leaf skid apparatus itself.
